(19) United States
(12) Patent Application Publication
(10) Pub. No.: US 2025/0128831 A1
(43) Pub. Date: Apr. 24, 2025

(54) IDENTIFYING A SPACE VEHICLE DECOUPLING LOCATION USING REINFORCEMENT LEARNING

(71) Applicant: International Business Machines Corporation, Armonk, NY (US)

(72) Inventors: Sarbajit K. Rakshit, Kolkata (IN); Sathya Santhar, Chennai (IN); Sridevi Kannan, Chennai (IN)

(21) Appl. No.: 18/491,041

(22) Filed: Oct. 20, 2023

(51) Int. Cl. B64G 1/24; B64G 1/64; G06N 10/60

(52) U.S. Cl. CPC B64G 1/24; B64G 1/646; G06N 10/60

(57) ABSTRACT

One or more systems, devices, computer program products and/or computer-implemented methods of use provided herein relate to identifying a decoupling location for a space vehicle using reinforcement learning. The computer-implemented system can comprise a memory that can store computer executable components. The computer-implemented system can further comprise a processor that can execute the computer executable components stored in the memory, wherein the computer executable components can comprise a decoupling component that can use an input from a reinforcement learning model to identify a first location that can be in space, for decoupling a space vehicle from an in-space manufacturing unit, such that the space vehicle can land at a second location that can be on a planetary surface.

### BACKGROUND

The subject disclosure relates to machine learning, and more specifically to identifying a decoupling location for a space vehicle using reinforcement learning.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable identification of a decoupling location for decoupling a space vehicle from an in-space manufacturing unit are discussed.

According to an embodiment, a computer-implemented system is provided. The computer-implemented system can comprise a memory that can store computer executable components. The computer-implemented system can further comprise a processor that can execute the computer executable components stored in the memory, where the computer executable components can comprise a decoupling component that can use an input from a reinforcement learning model to identify a first location that can be in space, for decoupling a space vehicle from an in-space manufacturing unit, such that the space vehicle can land at a second location that can be on a planetary surface.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can identify a decoupling location for a space vehicle in an in-space manufacturing ecosystem in accordance with one or more embodiments described herein.

FIG. 2 illustrates example, non-limiting decoupling locations of space vehicles and trajectories that can be utilized for landing the space vehicles at various locations on Earth in accordance with one or more embodiments described herein.

FIG. 3 illustrates example, non-limiting orbital paths for an in-space manufacturing unit and delivery locations on Earth for delivering products manufactured by the in-space manufacturing unit in accordance with one or more embodiments described herein.

FIG. 4 illustrates example, non-limiting paths that can be utilized for delivering products manufactured in space to various locations on Earth in accordance with one or more embodiments described herein.

FIG. 5 illustrates an example, non-limiting diagram of using reinforcement learning to identify a decoupling location for a space vehicle in an in-space manufacturing ecosystem in accordance with one or more embodiments described herein.

FIG. 6 illustrates an example, non-limiting Q-table construction process that can be employed for training a reinforcement learning agent to identify a decoupling location for a space vehicle in an in-space manufacturing ecosystem in accordance with one or more embodiments described herein.

FIG. 7 illustrates an example, non-limiting Q-table based on a state transition process that can be implemented by a reinforcement learning model for identifying a decoupling location for a space vehicle in an in-space manufacturing ecosystem in accordance with one or more embodiments described herein.

FIG. 8 illustrates a flow diagram of an example, non-limiting method that can identify a decoupling location for a space vehicle in an in-space manufacturing ecosystem in accordance with one or more embodiments described herein.

FIG. 9 illustrates another flow diagram of an example, non-limiting method that can identify a decoupling location for a space vehicle in an in-space manufacturing ecosystem in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Microgravity refers to a condition wherein gravity is very less, for example, as compared to gravity on Earth. “Micro” means “very small,” and although commonly referred to as “zero gravity,” microgravity is not the absence of gravity. The effects of microgravity can be seen when astronauts and objects float in space, wherein microgravity causes people and objects to appear weightless. Microgravity can be experienced in various ways. Under microgravity, astronauts can float inside a spacecraft, or outside of a spacecraft during a spacewalk. Further, microgravity allows heavy objects to be moved easily, for example, as compared to moving such objects on Earth. For example, under microgravity, astronauts can move equipment weighing hundreds of pounds with their fingertips.

In-space manufacturing (or ISM) can involve a comprehensive set of processes aimed at production of manufactured goods in the space environment. In-space manufacturing can also often be used interchangeably with the term “in-orbit manufacturing,” since current production capabilities can be limited to low Earth orbit. There can be several rationales supporting in-space manufacturing. For example, the space environment, specifically, the effects of microgravity and vacuum, can enable research and production of goods that can otherwise not be manufactured on Earth. Further, extraction and processing of raw materials from other astronomical bodies, also called in-situ resource utilization (ISRU) can enable more sustainable space exploration missions at reduced costs compared to launching resources from Earth. Raw materials can be transported to low Earth orbit for being processed into goods that can be shipped to Earth. Replacing terrestrial production on Earth can assist in preservation of the Earth, as well. Raw materials of very high value, for example, gold, silver, or platinum, can be transported to the low Earth orbit for processing or be transferred to Earth where the raw materials can become economically viable.

There are several unique differences between properties of materials in space and on Earth that can be exploited to produce unique or improved manufacturing techniques. The microgravity environment can allow control of convection in liquids or gasses and elimination of sedimentation. Diffusion can become the primary means of material mixing, allowing otherwise immiscible materials to be intermixed. The microgravity environment can also allow enhanced growth of larger, higher-quality crystals in solution. The ultraclean vacuum of space can permit the creation of very pure materials and objects. Vapor deposition can be utilized to build up materials layer by layer, free from defects. Under microgravity, surface tension can cause liquids to form perfect spheres, which can be problematic when trying to pump liquids through a conduit, but can be very useful when perfect spheres of consistent size are needed for specific applications. Space (i.e., the space environment, the microgravity environment) can provide readily available extremes of heat and cold. Sunlight can be focused to generate enough heat for melting materials, while objects kept in perpetual shade can be exposed to temperatures close to absolute zero. The temperature gradient of space can be exploited to produce strong, glassy materials.

However, multiple locations on Earth can need products and accordingly place requests for products manufactured in space, where failure of an in-space manufacturing unit to deliver the products at an appropriate location (e.g., at or nearer to a location where the products are to be delivered), can increase ground transportation costs. For example, an in-space manufacturing unit can manufacture a product to be delivered in Sri Lanka. If a space vehicle carrying the manufactured product lands in the United States of America (USA), surface transportation costs for delivering the manufactured product to Sri Lanka from the USA can be high. However, if the space vehicle can be landed at a location near Sri Lanka, the surface transportation cost can be minimized. Further, if all products manufactured in space are received at only one location on Earth, transportation of the products to various locations on Earth can increase an aggregate surface transportation cost and time for delivering the products. Thus, a method that can enable an in-space manufacturing unit to release orbital vehicles containing products manufactured in space, at appropriate decoupling points in space, causing the manufactured products to be delivered at appropriate locations (e.g., nearer to a delivery location for the manufactured products), can be desirable.

Various embodiments of the present disclosure can be implemented to solve one or more of the problems discussed above. Embodiments described herein can include systems, methods, apparatus and/or computer program products that can facilitate identification of a location for decoupling a space vehicle from an in-space manufacturing unit, using reinforcement learning, such that the space vehicle can land at a location, on a planetary surface, that can be within a defined geographical proximity to a delivery location, on the planetary surface for products comprised in the space vehicle. The planetary surface can be that of Earth such that the space vehicle can land at a dedicated location (e.g., an airport) on the surface of the Earth, or the planetary surface can be that of another planet. For example, based on one or more delivery locations on the Earth, an in-space manufacturing unit can take an input from a reinforcement learning model to identify a decoupling point for releasing a space vehicle comprising products manufactured by the in-space manufacturing unit, such that the space vehicle with the manufactured products can reach at a location nearer to (e.g., within a defined geographical proximity) a delivery location for the manufactured products. The input can comprise information about an optimal trajectory for a reinforcement learning agent (RL agent) to traverse from the decoupling point to the delivery location. Based on the input, the space vehicle and/or another RL agent can optimally traverse towards the end goal (i.e., delivery location on Earth) by learning an optimal trajectory.

Generally, an RL agent can be a means of transportation by which goods manufactured in space can be transported from one location to another (e.g., from space to Earth, between different locations on Earth, etc.). For example, for transporting manufactured goods from the in-space manufacturing unit to Earth, the space vehicle can be the RL agent. Thereafter, a ship, aircraft, truck, or another vehicle on ground can be the RL agent. A data center on Earth can identify a path (e.g., via reinforcement learning) for the manufactured goods to be delivered to the delivery location from the decoupling point, and various RL agents (e.g., space shuttle, ship, aircraft, train, truck, etc.) that can be involved in delivering the manufactured goods to the delivery location can coordinate with one another based on information received from the data center. For example, based on data received from the data center, a space vehicle can become the RL agent from the decoupling point to a receiving location on Earth, and a truck can become the RL agent from the receiving location to the delivery location, wherein the truck can take control of the manufactured goods from the receiving location to the delivery location. As such, multiple RL agents can be orchestrated by one or more data centers or a computing algorithm running at a data center.

The reinforcement learning model can use Q-learning to learn the optimal trajectory, wherein the reinforcement learning model can consider the decoupling point and one or more locations on the planetary surface as independent states on a Q-table. The reinforcement learning model can also consider environmental parameters, ground weather conditions, time taken for one or more individual paths from space to the one or more locations on ground, and an urgency of need of the manufactured products at the one or more locations to learn the optimal trajectory. Using the input from the reinforcement learning model, an RL agent can initialize the Q-table, observe a current state of the RL agent and conditions to traverse to a subsequent state to determine the subsequent state and determine relevant actions to be performed to reach the subsequent state. Based on the learning, the RL agent can select and perform an action to transit to the subsequent state, observe and measure a reward for the transition and a temporal difference between the current state and the subsequent state and update the Q-table. As stated elsewhere herein, the RL agent can spawn different units based on the environment, and the RL agent need not be a single independent unit. For example, a space shuttle comprising manufactured products can be an initial RL agent, and upon reaching the ground, the RL agent can be transitioned to a ship or aircraft for transporting the manufactured products to another location and so on until the end goal can be achieved. That is, a ship, an aircraft or another transport vehicle can be the RL agent, while delivering the manufactured products to a delivery location, after the manufactured products are delivered on ground.

In an embodiment, for delivering manufactured products to multiple geographical locations on Earth, various embodiments of the present disclosure can engage multiple individual in-space manufacturing units and decouple one or more respective space vehicles at appropriate locations in space, such that the manufactured products can be delivered to the multiple geographical locations. In-space manufacturing units, ground manufacturing units and ground supply chain units can collaborate with one another to identify appropriate decoupling and release locations in space for a space vehicle, such that ground supply chain operations can be optimized. Further, various embodiments of the present disclosure can analyze a warehouse space on Earth and an inventory of products, to enable an in-space manufacturing system to identify appropriate decoupling and release locations for space vehicles, such that a ground inventory carrying cost can be optimized (e.g., minimized). Based on a delivery location for the manufactured products, various embodiments of the present disclosure can also send a space vehicle containing the manufactured products from one in-space manufacturing unit to another orbital in-space manufacturing unit, such that manufactured products can be delivered at the delivery location while optimizing (e.g., minimizing) a surface transportation cost, for example, when the other orbital in-space manufacturing unit is closer to the delivery location.

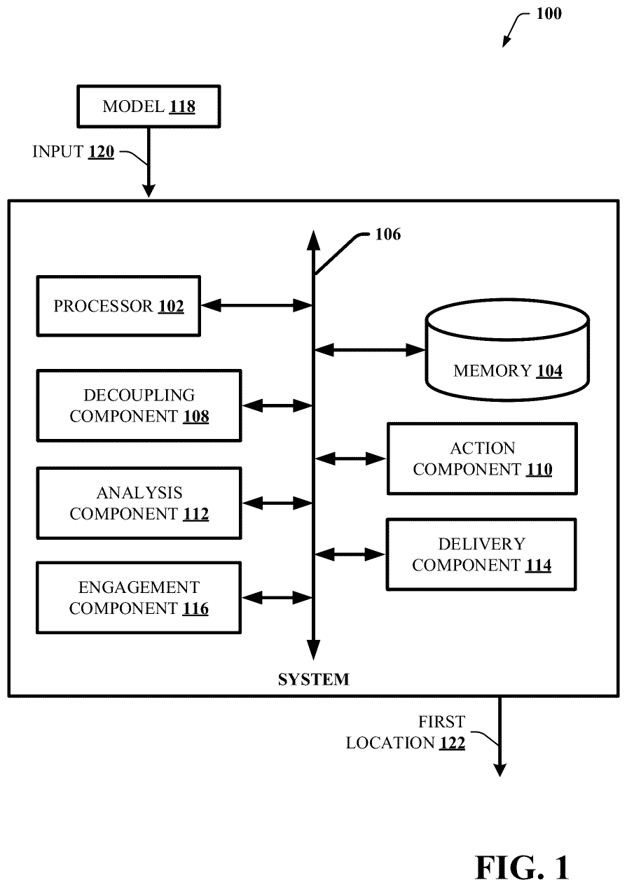

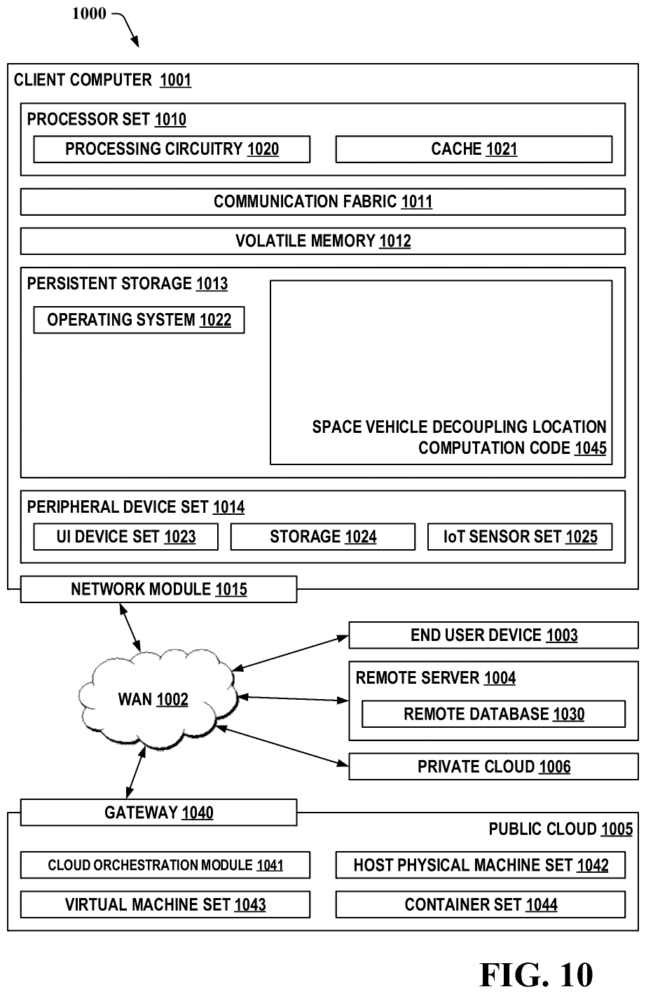

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can identify a decoupling location for a space vehicle in an in-space manufacturing ecosystem in accordance with one or more embodiments described herein. System 100 can comprise processor 102, memory 104, system bus 106, decoupling component 108, action component 110, analysis component 112, delivery component 114 and engagement component 116.

System 100 and/or the components of system 100 can be employed to use hardware and/or software to solve problems that are highly technical in nature (e.g., related to identifying a decoupling location for a space vehicle in an in-space manufacturing ecosystem to deliver products manufactured in space to a location on a planetary surface), that are not abstract and that cannot be performed as a set of mental acts by a human. Further, some of the processes performed may be performed by specialized computers for carrying out defined tasks related to identifying the decoupling location for the space vehicle in the in-space manufacturing ecosystem. The system 100 and/or components of the system can be employed to solve new problems that arise through advancements in technologies mentioned above, computer architecture, and/or the like.

The system 100 can provide technical improvements in terms of efficient utilization of computing power. For example, a logic involved in performing various processes of the one or more embodiments disclosed herein (e.g., identifying the decoupling location for the space vehicle in the in-space manufacturing ecosystem, computing a trajectory for the space vehicle from the decoupling point to a location on Earth, etc.) can be spread out between data centers on ground and data centers in space (e.g., in an in-space manufacturing unit). For example, instead of all machine learning computations performed by a single data center, the machine learning computations can be executed in a hybrid environment, such that a portion (80%) of the computations can run on ground and another portion (20%) can run in a data center in space. Since a data center in space can have a limited amount of computing power to execute certain operations, such a hybrid setting can assist in conserving the computing power available in space and increase a capacity of data that can be handled by the data center in space by offloading some computations to Earth.

Additionally, since most communication in space can occur in a batch mode versus in real-time due to lower availability of bandwidth in space, a delay in the space vehicle receiving information from a data center on Earth can be prevented if computations can be performed by a data center in space during times of emergency. For example, a major change in parameters used to perform some computations or an event can occur on Earth (e.g., a natural disaster) half an hour before a space vehicle carrying products manufactured in space is to be decoupled. A data center on Earth can rerun an algorithm and recompute a new trajectory to redirect the space vehicle to a different location on Earth than previously intended and communicate the new trajectory to the space vehicle. However, since most communication in space can occur in batch mode versus in real-time due to lower availability of bandwidth, there can be a delay in the space vehicle receiving information about the new trajectory from the data center on ground. In such a scenario, the space vehicle can become decoupled and released along the old trajectory, causing the space vehicle to land at an incorrect location. Such a scenario can be prevented if computations can be performed by a data center in space to determine the new trajectory, such that the space vehicle can receive real-time information about the new trajectory, for example, versus receiving the information after a delay.

Discussion turns briefly to processor 102, memory 104 and bus 106 of system 100. For example, in one or more embodiments, system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to processor 102. Memory 104 can store computer-executable instructions that, upon execution by processor 102, can cause processor 102 and/or one or more other components of system 100 (e.g., decoupling component 108, action component 110, analysis component 112, delivery component 114 and/or engagement component 116) to perform one or more actions. In one or more embodiments, memory 104 can store computer-executable components (e.g., decoupling component 108, action component 110, analysis component 112, delivery component 114 and/or engagement component 116).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

As described above, in addition to processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, decoupling component 108 can use input 120 from model 118, to identify first location 122, and decoupling component 108 can decouple the space vehicle at first location 122 based on input 120. First location 122 can be a location in space where a space vehicle can be decoupled from an in-space manufacturing unit, such that the space vehicle can land at a second location that can be on a planetary surface. Model 118 can be a reinforcement learning model, which is a type of a machine learning model. The planetary surface can be that of Earth such that the space vehicle can land at a dedicated location (e.g., an airport) on the surface of the Earth, or the planetary surface can be that of another planet.

The space vehicle can comprise products manufactured in space by the in-space manufacturing unit, and the second location can be within a defined geographical proximity to a delivery location on the planetary surface, for the products. The space vehicle can be a space-shuttle, spacecraft, or another type of space vehicle that can deliver the products to the planetary surface. In-space manufacturing can comprise three-dimensional (3D) manufacturing, including bioprinting, and the products manufactured by the in-space manufacturing unit can include fiber optic cables, bio printed organs such as heart and lungs, and/or other types of 3D manufactured products. For example, in the future, most fiber optics can be manufactured in space because, as stated elsewhere herein, a quality of manufacturing can be superior in the microgravity environment of space. For example, dust particle that can become associated with fiber optic cables can cause light travelling through the fiber optic cables to get deflected in an undesired direction, increasing chances of data losses. However, due to absence of dust particles in space, high quality fiber optics can be manufactured. Similarly, a quality of manufacturing of bio printed products and other products can be improved by manufacturing the products in space.

Input 120 can comprise information about a trajectory that the space vehicle can traverse from first location 122 to the second location. Model 118 (e.g., a reinforcement learning model) can use Q-learning to learn the trajectory, wherein model 118 can consider first location 122 and the second location as respective independent states on a Q-table to learn the trajectory. Model 118 can further consider environmental parameters, ground weather conditions, a time duration in which the space vehicle can traverse the trajectory from the first location to the second location and need of products comprised in the space vehicle to learn the trajectory. Action component 110 can use the trajectory to identify one or more actions to be executed by the space vehicle to traverse from first location 122 to the second location.

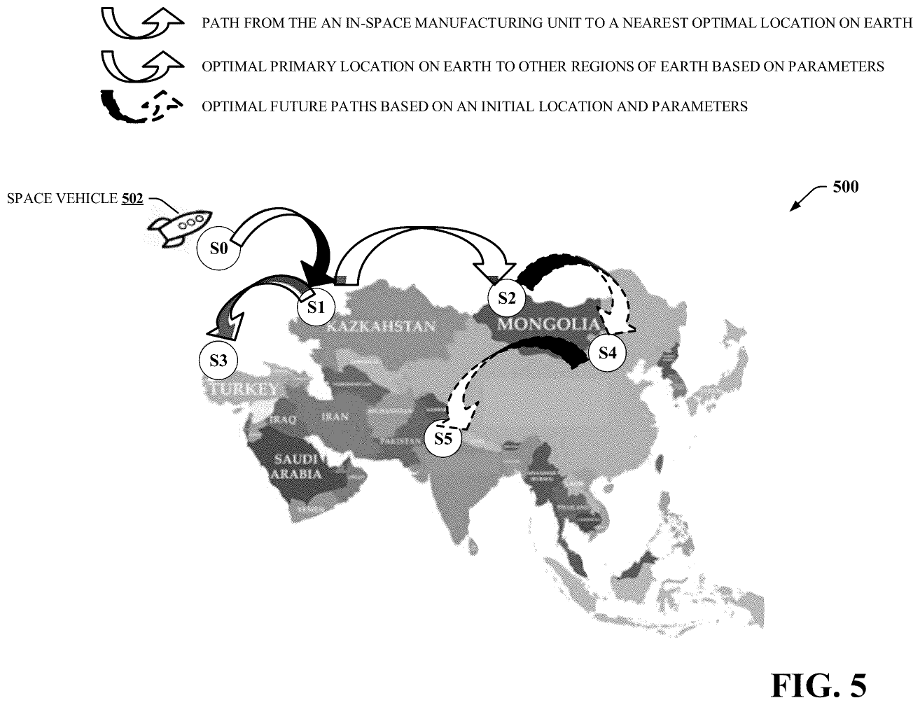

An objective of Q-learning can be to learn a policy which can inform the RL agent about actions that the RL agent can take for maximizing a reward under various circumstances. As such, model 118 can consider the decoupling point and one or more locations on Earth as respective independent states on the Q-table to determine an optimal trajectory for one or more RL agents to deliver products manufactured in space to delivery locations on Earth. For example, model 118 can consider a starting point of the space vehicle as an initial state, a delivery location for the manufactured products comprised in the space vehicle as an end state, and multiple other locations on the planetary surface as intermediary states on the Q-table to determine an action that can be performed by an RL agent (e.g., the space vehicle, ship, aircraft, etc.) to traverse from the initial state to the end state based on time constraints, weather conditions and other such parameters. An optimal trajectory can mean a best trajectory for an RL agent to deliver the manufactured products given various parameters such as time constraints, cost constraints, environmental factors, etc. Additional aspects of training and Q-learning have been described in greater detail with reference to FIGS. 5, 6 and 7.

In an embodiment, analysis component 112 can analyze a warehouse area and an inventory on the planetary surface, to identify first location 122 for decoupling the space vehicle, such that a surface transportation cost and a transportation time associated with the products can be maintained below respective defined thresholds. For example, analysis component 112 can analyze a warehouse area and an inventory on Earth, such that a surface transportation cost for delivering products comprised in the space vehicle to the delivery location can be maintained below a defined cost threshold, and a corresponding transportation time for delivering the products can be maintained below a defined time threshold. Analysis component 112 can prioritize whether the surface transportation cost, transportation time, or both are to be optimized based on a context. For example, a flight from the second location to the delivery location can be expensive but time efficient, whereas a train from the second location to the delivery location can be cost efficient but take a longer time to reach the delivery location. Thus, for delivering a bio printed heart manufactured in space to the delivery location, for a heart surgery, analysis component 112 can prioritize minimizing the transportation time.

In an embodiment, delivery component 114 can deliver the space vehicle to a different in-space manufacturing unit, for landing the space vehicle at the second location, such that a surface transportation cost and a transportation time associated with the products can be maintained below respective defined thresholds. For example, delivery component 114 can deliver the space vehicle to a different in-space manufacturing unit, for landing the space vehicle at the second location, such that the surface transportation cost for delivering the products comprised in the space vehicle to the delivery location can be maintained below a defined cost threshold and a corresponding transportation time for delivering the products can be maintained below a defined time threshold. Delivery component 114 can prioritize whether the surface transportation cost, transportation time, or both are to be optimized based on a context. For example, a flight from the second location to the delivery location can be expensive but time efficient, whereas a train from the second location to the delivery location can be cost efficient but take a longer time to reach the delivery location. Thus, for delivering products manufactured in space to the delivery location, without time constraints being a factor, delivery component 114 can prioritize minimizing the transportation cost.

In an embodiment, engagement component 116 can engage at least a second in-space manufacturing unit to deliver products comprised in the space vehicle to a third location on the planetary surface, in addition to the second location. For example, a first in-space manufacturing can communicate with at least a second in-space manufacturing unit to engage the second in-space manufacturing unit, via engagement component 116. Further, one or more ground manufacturing units can collaborate with the in-space manufacturing unit and one or more ground supply chain units to identify first location 122 for decoupling the space vehicle such that supply chain operations can be minimized. For example, system 100 can identify a supply chain unit, a warehouse location and ground transportation system(s) for delivering the manufactured products from the second location to the delivery location. The ground transportation system(s) can receive the manufactured products from the space vehicle and carry the manufactured products to the delivery location (e.g., by roads, waterways, etc.). An in-space manufacturing computing system (e.g., system 100) can further identify an inventory in different warehouses on the planetary surface for delivering the manufactured products.

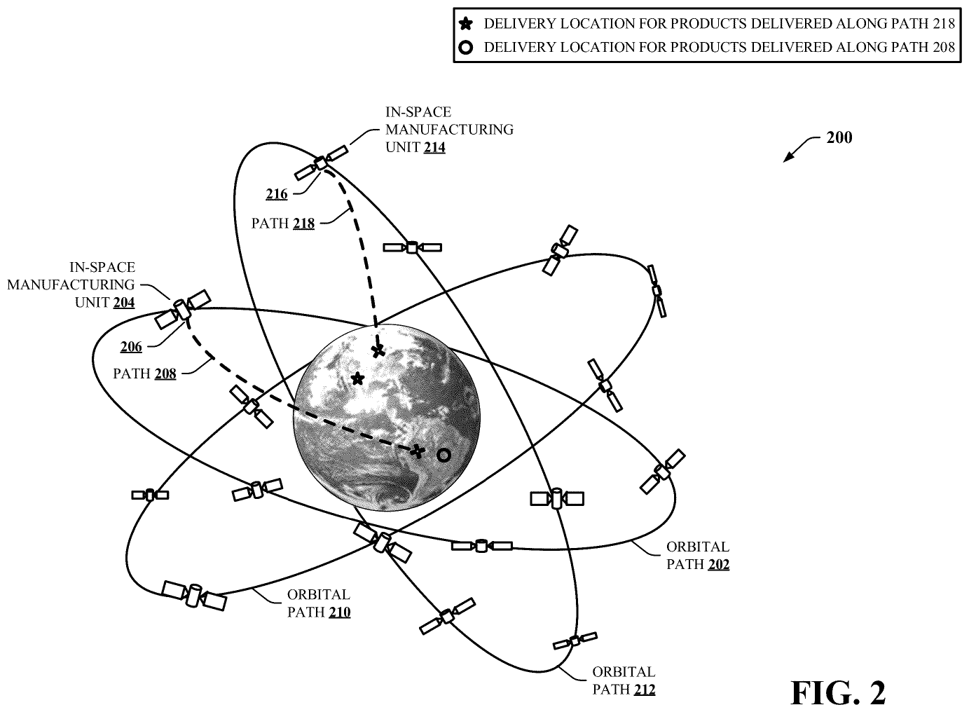

FIG. 2 illustrates example, non-limiting decoupling locations of space vehicles and trajectories that can be utilized for landing the space vehicles at various locations on Earth in accordance with one or more embodiments described herein. One or more embodiments described with respect to FIG. 2 can be implemented by one or more components of system 100 illustrated in FIG. 1. Repetitive description of like elements and/or processes employed in respective embodiments is omitted for sake of brevity.

FIG. 2 illustrates, at 200, multiple satellites orbiting around the Earth, wherein some satellites can be in-space manufacturing units dedicated for manufacturing products in space. The in-space manufacturing units can orbit along different orbital paths. For example, the in-space manufacturing units can respectively orbit along orbital path 202, orbital path 210 and orbital path 212. The in-space manufacturing units can be situated in low Earth orbit. Similar to the International Space Station (ISS) that can revolve around the Earth at about 17,500 miles per hour (mph) (˜28,000 kilometers per hour (km/h)), resulting in the ISS completing 1 revolution in about 90 minutes and about 16 revolutions per day, an in-space manufacturing unit can orbit the Earth about 8-10 times in 24 hours. As with the ISS, techniques known in the art can be used for docking and de-docking a space vehicle from an in-space manufacturing unit, such as by using cameras and sensors for alignment.

In one or more embodiments, a system (e.g., system 100) can facilitate identification of a location for decoupling a space vehicle (e.g., by decoupling component 108) from an in-space manufacturing unit, using reinforcement learning, such that the space vehicle can land at a location on a planetary surface, that can be within a defined geographical proximity to a delivery location on the planetary surface for products comprised in the space vehicle. For example, based on one or more delivery locations on the Earth, an in-space manufacturing unit can take an input from a reinforcement learning model to identify a decoupling point for releasing a space vehicle comprising products manufactured by the in-space manufacturing unit, such that the space vehicle with the manufactured products can reach at a location nearer to (e.g., within a defined geographical proximity) a delivery location for the manufactured products. As stated elsewhere herein, the space vehicle can be a space-shuttle, spacecraft, or another type of space vehicle that can deliver the products to the planetary surface. The space vehicle can act as an RL agent that can optimally traverse towards the end goal (i.e., on Earth) by learning an optimal trajectory.

In one or more embodiments, an RL agent can be the space vehicle, or another means by which goods manufactured in space can be transported to various locations (e.g., from space to Earth, between different locations on Earth, etc.). For example, for transporting manufactured goods from the in-space manufacturing unit to Earth, the space vehicle can be the RL agent. Thereafter, a ship, aircraft, truck, or another vehicle on ground can be the RL agent. A data center on Earth can identify a path (e.g., via reinforcement learning) for the manufactured goods to be delivered to the delivery location from the decoupling point, and various RL agents (e.g., space shuttle, ship, aircraft, train, truck, etc.) that can be involved in delivering the manufactured goods to the delivery location can coordinate with one another based on information received from the data center. For example, based on data received from the data center, a space vehicle can assume a role as the RL agent from the decoupling point to a receiving location on Earth, and a ship can assume a role as the RL agent from the receiving location to the delivery location. Thus, the ship can take control of the manufactured goods from the receiving location to the delivery location. As such, multiple RL agents can be orchestrated by one or more data centers or a computing algorithm running at a data center.

The system (e.g., decoupling component 108) can identify appropriate delivery locations on Earth based on needs of products manufactured in space, and the system can identify geographical areas where a space vehicle can reach (e.g., on water, on ground, etc.). Based on a delivery location for the manufactured products, the system (e.g., engagement component 116) can engage an appropriate in-space manufacturing unit to manufacture the products. The system can identify orbital paths of different in-space manufacturing units since there can be different orbital paths around Earth for the different in-space manufacturing units. The system can further identify an in-space manufacturing unit having the closest orbital path to the delivery location, and the system can engage the in-space manufacturing unit for manufacturing the products. For example, in-space manufacturing unit 204 can be identified by the system as the in-space manufacturing unit having the closest orbital path (e.g., orbital path 202) to a delivery location on Earth for the manufactured products.

During manufacturing of the products by in-space manufacturing unit 204, the system can identify receiving locations (e.g., second location(s)) on Earth for the products where the space vehicle carrying the manufactured products can land. The system (e.g., decoupling component 108) can also compute a location for deorbiting the space vehicle comprising the manufactured products, using reinforcement learning, such that the space vehicle can land at an appropriate receiving location based on a delivery location. After manufacturing of the products, the manufactured products can be filled in the space vehicle, and the system (e.g., decoupling component 108) can decouple and release the space vehicle comprising the products at location 206 on orbital path 202 of in-space manufacturing unit 204, such that a surface transportation cost for delivering the products to the delivery location on Earth can be maintained below a defined cost threshold and/or a corresponding time for delivering the products can be maintained below a time threshold.

The space vehicle carrying the manufactured products can be decoupled (e.g., by decoupling component 108) from in-space manufacturing unit 204 at location 206 (e.g., first location 122), and the space vehicle can traverse path 208 (e.g., a projectile path) to reach a location on Earth (e.g., second location) where the manufactured products can be received. In FIG. 2, the receiving location (e.g., second location) can be illustrated by the cross mark at the end of path 208. Thereafter, the products can be transported on ground to a delivery location where the products can be needed. In FIG. 2, the delivery location for products delivered along path 208 is illustrated by the circle symbol, as is also indicated by the legend. The system (e.g., analysis component 112) can identify a supply chain unit, a warehouse location and ground transportation system(s) for delivering the manufactured products to the delivery location. The ground transportation system(s) can receive the manufactured products from the space vehicle and carry the manufactured products to the delivery location (e.g., by roads, waterways, etc.). An in-space manufacturing computing system (e.g., system 100, analysis component 112) can further identify an inventory in different warehouses on Earth for delivering the manufactured products. Thus, based on the end goal (i.e., final delivery location on ground), in-space manufacturing unit 204 can decouple the space vehicle carrying the products manufactured in space at location 206, and the space vehicle can traverse along path 208 to reach a first destination on ground, whereby the products can be transported to a final delivery location.

Based on the delivery location, in-space manufacturing unit 204 can take an input (e.g., input 120) from a reinforcement learning model (e.g., model 118) to identify a decoupling point (e.g., location 206) and release the space vehicle with the manufactured products at the decoupling point, such that the space vehicle with the manufactured products can be received at a location within a defined geographical proximity to the delivery location. In an embodiment, raw materials can be delivered through a space vehicle and in-space manufacturing unit 204 can manufacture products per a design, using the raw materials. The input can comprise information about path 208 for the space vehicle to traverse to reach the first destination (e.g., indicated by the cross) from location 206, wherein path 208 can be an optimal trajectory determined by the reinforcement learning model. For example, the reinforcement learning model can use Q-learning to learn the trajectory, wherein the reinforcement learning model can consider location 206, the first destination and one or more delivery locations on Earth as respective independent states on a Q-table to learn the trajectory. The reinforcement learning model can further consider environmental parameters, ground weather conditions, a time needed to traverse path 208 and/or another trajectory from the first location to the second location and need of products comprised in the space vehicle, to learn the trajectory. The main objective of Q-learning can be to learn a policy which can inform an RL agent (e.g., a space vehicle) about actions that the RL agent can take for maximizing a reward under various circumstances. Additional aspects of the Q-learning implemented by various embodiments of the present disclosure have been described in greater detail with reference to FIGS. 5, 6 and 7.

Manufacturing of products via in-space manufacturing can be controlled by ground computing systems. Requests for manufacturing the products can be received by the in-space manufacturing units from different geographical locations on Earth. In an embodiment, the system (e.g., delivery component 114) can send the space vehicle to an appropriate in-space manufacturing unit, such that manufactured products can be delivered at a location nearest to a delivery location requesting the products. In another embodiment, for delivering manufactured products to multiple geographical locations on Earth, the system (e.g., engagement component 116) can engage multiple in-space manufacturing units and decouple (e.g., via decoupling component 108) one or more space vehicles at appropriate locations in space, such that the manufactured products can be delivered to the multiple geographical locations. For example, in addition to in-space manufacturing unit 204, the system can engage in-space manufacturing unit 214, wherein in-space manufacturing unit 214 can decouple a space vehicle carrying products manufactured by in-space manufacturing unit 214, at location 216, and the space vehicle can traverse along path 218 to reach a first destination (e.g., second location) on ground, whereby the products can be transported to a final delivery location. In FIG. 2, the receiving location (e.g., second location) corresponding to in-space manufacturing unit 214 is illustrated by the cross mark at the end of path 218, and the delivery location for products delivered along path 218 is illustrated by the star symbol, as also defined in the legend.

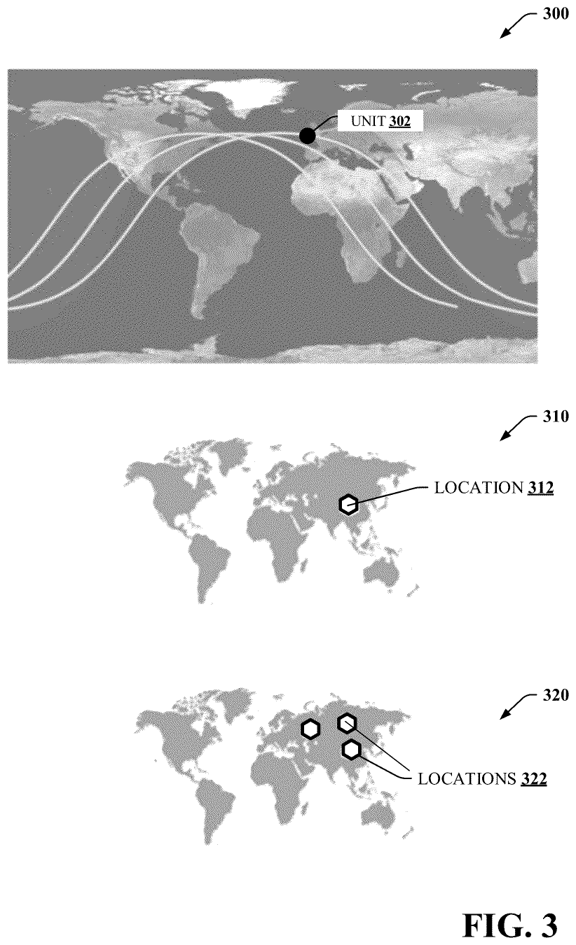

FIG. 3 illustrates example, non-limiting orbital paths for an in-space manufacturing unit and delivery locations on Earth for delivering products manufactured by the in-space manufacturing unit in accordance with one or more embodiments described herein. One or more embodiments described with respect to FIG. 3 can be implemented by one or more components of system 100 illustrated in FIG. 1. Repetitive description of like elements and/or processes employed in respective embodiments is omitted for sake of brevity.

In one or more embodiments, a system (e.g., system 100) can facilitate identification of a location for decoupling a space vehicle from an in-space manufacturing unit, using reinforcement learning, such that the space vehicle can land at a location on a planetary surface, that can be within a defined geographical proximity to a delivery location on the planetary surface for products comprised in the space vehicle. For example, based on one or more delivery locations on the Earth, an in-space manufacturing unit can take an input from a reinforcement learning model to identify a decoupling point for releasing a space vehicle comprising products manufactured by the in-space manufacturing unit, such that the space vehicle with the manufactured products can reach at a location nearer to (e.g., within a defined geographical proximity) a delivery location for the manufactured products. As stated elsewhere herein, the space vehicle can be a space-shuttle, spacecraft, or another type of space vehicle that can deliver the products to the planetary surface.

FIG. 3 illustrates, at 300, unit 302 which can be an in-space manufacturing unit orbiting the Earth on an orbital path indicated by the waved line. With continued reference to FIG. 2, unit 302 can be one of many in-space manufacturing units, situated in low Earth orbit, that can revolve around the Earth about 8-10 times in one day. Different in-space manufacturing units can have different proximities to different geographical locations on Earth. As such, requests for manufacturing the products can be received by in-space manufacturing units from different geographical locations on Earth, and a system (e.g., system 100) can identify one or more delivery locations for products manufactured in space. For example, as illustrated at 310 in FIG. 3, the system can identify location 312 for delivering the manufactured products, or as illustrated at 320 in FIG. 3, the system can identify multiple locations 322 for delivering the manufactured products.

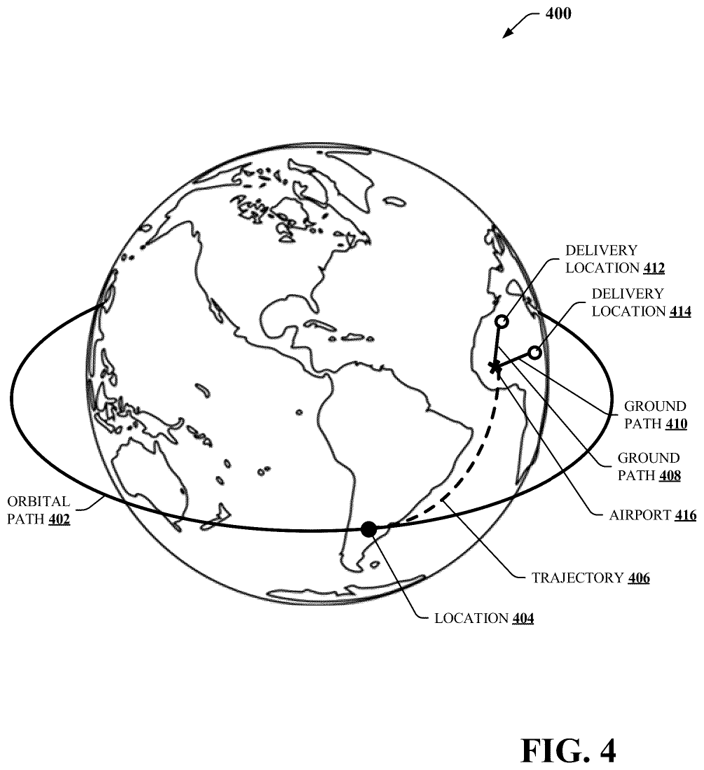

FIG. 4 illustrates example, non-limiting paths that can be utilized for delivering products manufactured in space to various locations on Earth in accordance with one or more embodiments described herein. One or more embodiments described with respect to FIG. 4 can be implemented by one or more components of system 100 illustrated in FIG. 1. Repetitive description of like elements and/or processes employed in respective embodiments is omitted for sake of brevity.

In one or more embodiments, a system (e.g., system 100) can facilitate identification of a location for decoupling a space vehicle from an in-space manufacturing unit, using reinforcement learning, such that the space vehicle can land at a location on a planetary surface, that can be within a defined geographical proximity to a delivery location on the planetary surface for products comprised in the space vehicle. For example, based on one or more delivery locations on the Earth, an in-space manufacturing unit can take an input from a reinforcement learning model to identify a decoupling point for releasing a space vehicle comprising products manufactured by the in-space manufacturing unit, such that the space vehicle with the manufactured products can reach at a location nearer to (e.g., within a defined geographical proximity) a delivery location for the manufactured products. As stated elsewhere herein, the space vehicle can be a space-shuttle, spacecraft, or another type of space vehicle that can deliver the products to the planetary surface.

In an embodiment, the system (e.g., decoupling component 108) can identify, at 400, delivery location 412 and delivery location 414 as delivery locations for products manufactured in-space. Based on the delivery locations, the system (e.g., decoupling component 108) can identify potential geographical locations on Earth where a space vehicle carrying the manufactured products can land. For example, the system can identify airport 416 as a geographical location where the space vehicle can land, such that the manufactured products can be delivered to the delivery location 412 and delivery location 414. Airport 416 can be within a geographic proximity to delivery location 412 and delivery location 414 such that airport 416 can be a nearest location to delivery location 412 and delivery location 414 for receiving the space vehicle. Further, the system (e.g., decoupling component 108) can compute an orbital position of a space manufacturing module that can manufacture the products requested at delivery location 412 and delivery location 414, and the system (e.g., decoupling component 108) can compute an altitude of an orbit of the space manufacturing module from Earth. For example, the space manufacturing module can orbit the Earth on orbital path 402, and the system can compute an altitude of orbital path 402 from Earth.

In an embodiment, the system (e.g., analysis component 112) can calculate a first surface transportation cost and a first transportation time for delivering the manufactured products from airport 416 to delivery location 412, for example, along ground path 408. The system (e.g., analysis component 112) can also calculate a second surface transportation cost and a second transportation time for delivering the manufactured products from airport 416 to delivery location 414, for example, along ground path 410. Based on the first surface transportation cost and the second surface transportation cost, the system (e.g., analysis component 112) can calculate an aggregate surface transportation cost for delivering the manufactured products to delivery location 412 and delivery location 414. Likewise, based on the first transportation time and the second transportation time, the system (e.g., analysis component 112) can calculate an aggregate transportation time for delivering the manufactured products to delivery location 412 and delivery location 414. Based on the aggregate surface transportation cost and the aggregate transportation time, the system (e.g., decoupling component 108) can identify an appropriate airport for receiving the manufactured products for delivery to the delivery locations such that a cost and time for delivering the products can be optimized (e.g., minimized). For example, the system can identify airport 416 as the appropriate airport where the space vehicle can land, such that the manufactured products can be delivered to the delivery location 412 and delivery location 414 while maintain a surface transportation cost below a defined cost threshold and/or a transportation time below a defined time threshold. It is to be appreciated that although only two delivery locations (e.g., delivery location 412 and delivery location 414) are illustrated in FIG. 4, the aggregate surface transportation cost and the aggregate transportation time can be based on additional delivery locations.

Upon selection of airport 416 as the appropriate airport for receiving the manufactured products and delivering the manufactured products to delivery location 412 and delivery location 414, based on proximity to the delivery locations and optimization of the surface transportation cost and the transportation time, the system (e.g., decoupling component 108) can compute trajectory 406, wherein the space vehicle can traverse trajectory 406 from an orbital position of the space manufacturing module (e.g., location 404) to airport 416. The system (e.g., decoupling component 108) can further compute location 404 as a decoupling point for decoupling and releasing the space vehicle from the space manufacturing module on orbital path 402. The system can compute trajectory 406 based on reinforcement learning, wherein a reinforcement learning model (e.g., model 118) can use Q-learning to learn trajectory 406. The main objective of Q-learning can be to learn a policy which can inform an RL agent (e.g., a space vehicle, ship, truck, or other ground vehicle, etc.) about actions that the RL agent can take for maximizing a reward under various circumstances.

The system can compute location 404 as the decoupling point for the space vehicle based on historical learning, an orbiting profile of the space manufacturing module and trajectory 406, that can be pre-computed based on data available from data centers in space and on Earth (or another planetary surface). Further, the system can consider weather conditions and other environmental factors to compute location 404 as the decoupling point for the space vehicle. For example, in case of bad weather around airport 416, the system can identify a different airport where the space vehicle can land for delivering the manufactured products to delivery location 412 and delivery location 414. It is to be appreciated that airport 416 can be one of many airports designed to receive the space vehicle. With in-space manufacturing becoming more common, private and government organizations can participate to create multiple airports for launching or landing a space vehicle carrying products manufactured in space.

Turning now to FIGS. 5-7, aspects of reinforcement learning and a reinforcement learning system with RL agents, states, transitions between states and environmental parameters controlling the transition between states have been described in greater details in accordance with various embodiments herein.

FIG. 5 illustrates an example, non-limiting diagram 500 of using reinforcement learning to identify a decoupling location for a space vehicle in an in-space manufacturing ecosystem in accordance with one or more embodiments described herein. One or more embodiments described with respect to FIG. 5 can be implemented by one or more components of system 100 illustrated in FIG. 1. Repetitive description of like elements and/or processes employed in respective embodiments is omitted for sake of brevity.

In one or more embodiments, based on one or more delivery locations on Earth, an in-space manufacturing unit can take an input (e.g., input 120) from a reinforcement learning model (e.g., model 118) to identify a decoupling point for releasing space vehicle 502 comprising products manufactured by the in-space manufacturing unit, such that space vehicle 502 can reach at a location nearer to (e.g., within a defined geographical proximity) a delivery location for the manufactured products. As stated elsewhere herein, space vehicle 502 can be a space-shuttle, spacecraft, or another type of space vehicle that can deliver the products to the planetary surface.

The input from the reinforcement learning model can comprise information about a trajectory for space vehicle 502 to traverse from the decoupling point to the second location, the reinforcement learning model can use Q-learning to learn the trajectory. The main objective of Q-learning can be to learn a policy which can inform an RL agent (e.g., space vehicle 502, ship, aircraft, etc.) about actions that the RL agent can take for maximizing a reward under various circumstances, and the reinforcement learning model can consider the decoupling point and one or more locations on Earth as respective independent states on a Q-table to learn the trajectory. For example, as illustrated in FIG. 5, the reinforcement model can consider states S0, S1, S2, S3, S4 and S5 as states on a Q-table, wherein S0 can represent a starting point of space vehicle 502 (i.e., at the decoupling point in space), S1 can represent a geographical location in Kazakhstan, S2 can represent a geographical location in Mongolia, S3 can represent a geographical location in Turkey, S4 can represent a geographical location in a first country in Asia and S5 can represent a geographical location in a second country in Asia. The arrow from S0 to S1 can indicate a path from the in-space manufacturing unit to a location on Earth that can be nearest to a delivery location for the manufactured products. The arrows from S1 to S2 and S1 to S3 can indicate paths from an optimal primary location on Earth (e.g., S1) to other respective regions on Earth (e.g., S2, S3) based on various parameters such as time duration, weather conditions, need of products, etc. The arrows from S2 to S4 and from S4 to S5 can indicate respective optimal future paths based on the initial location and the various parameters.

The reinforcement learning model can further consider environmental parameters, ground weather conditions, a time duration for traversing the trajectory from the decoupling point to the delivery location, need of products comprised in space vehicle 502, etc., to learn the trajectory. The trajectory can be used (e.g., by action component 110) to identify one or more actions to be executed by space vehicle 502 to traverse from the decoupling location to the delivery location. For example, the reinforcement learning model can consider the starting point of space vehicle 502 as an initial state (e.g., S0), the delivery location for the manufactured products comprised in space vehicle 502 as an end state (e.g., S5), and multiple other locations as intermediary states (e.g., S1, S2, S3 and S4) on the Q-table to determine an action that can be performed by an RL agent to traverse from the initial state to the end state based on time constraints, weather conditions and other such parameters. For example, for delivering goods from the decoupling point to a delivery location in the second country in Asia (i.e., from S0 to S5), space vehicle 502 can land directly at S5 under favorable weather conditions. Under unfavorable circumstances, wherein landing directly at S5 can be challenging for space vehicle 502, or when a need for the manufactured products at S5 is not immediate, reinforcement learning model can compute a path from S0 to S4 and from S4 to S5. For example, space vehicle 502 can land at S4, and the manufactured products can be transported from S4 to S5 via a cargo flight, provided all other conditions are satisfied. Thus, a goal of reinforcement learning can be to reach the end state directly or indirectly through multiple other states.

As stated elsewhere herein, the RL agent can be a space vehicle, or another means by which goods manufactured in space can be transported to various locations (e.g., between different locations on Earth, etc.). For example, for transporting manufactured goods from S0 to S1, space vehicle 502 can be the RL agent. Thereafter, a ship, aircraft, truck, or another vehicle on ground can be the RL agent (e.g., from S1 to S2, from S2 to S4, etc.). A data center on Earth and/or a data center in space can employ the reinforcement learning model to identify a path for the manufactured goods to be delivered to the delivery location from the decoupling point, and various RL agents (e.g., space shuttle, ship, aircraft, train, truck, etc.) that can be involved in delivering the manufactured goods to the delivery location can coordinate with one another based on information received from the data center. For example, based on data received from the data center, space vehicle 502 can act as the RL agent from S0 to S1, and an aircraft can act as the RL agent from S2 to S4. Thus, the aircraft can take control of the manufactured goods from S2 to S4. As such, multiple RL agents can be orchestrated by one or more data centers or a computing algorithm running at a data center.

The reinforcement learning model can be trained for the Q-learning on ground (e.g., on Earth), for example, even before space vehicle 502 can be launched into space. In an embodiment, the learning can be performed through a simulated model, wherein the simulated model can be trained to reach from one location to another (e.g., from one state to another) while traveling through various other locations (e.g., intermediary states), based on different parameters that can be simulated during training on ground. A dataset can be created to train the simulated model. For example, the dataset can be based on states S0-S5, and a model can be trained to find an optimal path to reach a final state (e.g., delivery location) given time constrains, state constraints that can define how many intermediary states the model can utilize and so on. Based on performance results of the model upon training of the model, a difference between an actual performance value and an expected performance value can be provided as feedback to the reinforcement learning model. For example, if the reinforcement learning model cannot reach an end state given various constraints, the difference between the actual performance value and the expected performance value of the reinforcement learning model can be provided as feedback to the reinforcement learning model, such that the reinforcement learning model can re-compute the path to the end state to reduce a gap between the actual performance value and the expected performance value.

Thus, a large amount of simulated data can be provided to the reinforcement learning model, and the reinforcement learning model can be trained to find an optimal path from the initial state to the end state. In an embodiment, the trained reinforcement learning model can be taken to space after being trained, and prior to space vehicle 502 beginning its journey, the trained reinforcement learning model can be used to identify the initial state (e.g., S0), the end state (e.g., S5), one or more intermediary states and one or more actions that can be taken at any given time. The final path thus computed to transport the manufactured products to the end state can be provided as an input to space vehicle 502 that can follow a trajectory (e.g., from S0 to S1) and/or to one or more other RL agents. The input can be provided from data centers in space or from data centers on Earth that can perform the computations. In an embodiment, a final path computed at a data center on Earth can be downloaded by an RL agent and executed. Wherein multiple in-space manufacturing units can be involved in manufacturing products, individual in-space manufacturing units can have respective computations performed by data centers.

In an embodiment, an in-space manufacturing unit can receive an input from a data center prior to space vehicle 502 being decoupled from the in-space manufacturing unit, wherein the input can indicate an amount of time (e.g., 3 hours), starting at a given point in time, in which the space vehicle can be decoupled (e.g., by decoupling component 108), such that space vehicle 502 can reach an intended location (e.g., S1) on Earth. The input can further indicate that at S1, ground transportation units can coordinate with space vehicle 502 so that the manufactured products can reach S5. Parameters such as environmental conditions, etc. can be predicted beforehand, thereby allowing the path of the manufactured products from the initial state to the end state to be pre-computed by the reinforcement learning model.

In another embodiment, an input comprising a delta path can be received by the in-space manufacturing unit. For example, an initial input from the reinforcement learning model to the in-space manufacturing unit can indicate that space vehicle 502 can be decoupled (e.g., by decoupling component 108) from the in-space manufacturing unit in 4 hours, from a given point in time, at a certain decoupling point. During the 4 hours, there can be a change in parameters used for the computation (e.g., a weather prediction change) of the input, which can cause a change in a path originally computed. Based on the change in the parameters, a data center can compute a delta path, wherein the in-space manufacturing unit can download the delta path and space vehicle 502 can be decoupled at a new decoupling point based on updated parameters. Likewise, adjustments to a path computed for transporting the manufactured products from a receiving location (e.g., second location) on Earth to another location on Earth (e.g., an intermediate location or a delivery location) can be made based on updated parameters. In this regard, adjustments to a path, for example, based on different environmental parameters, can be determined by various machine learning codes.

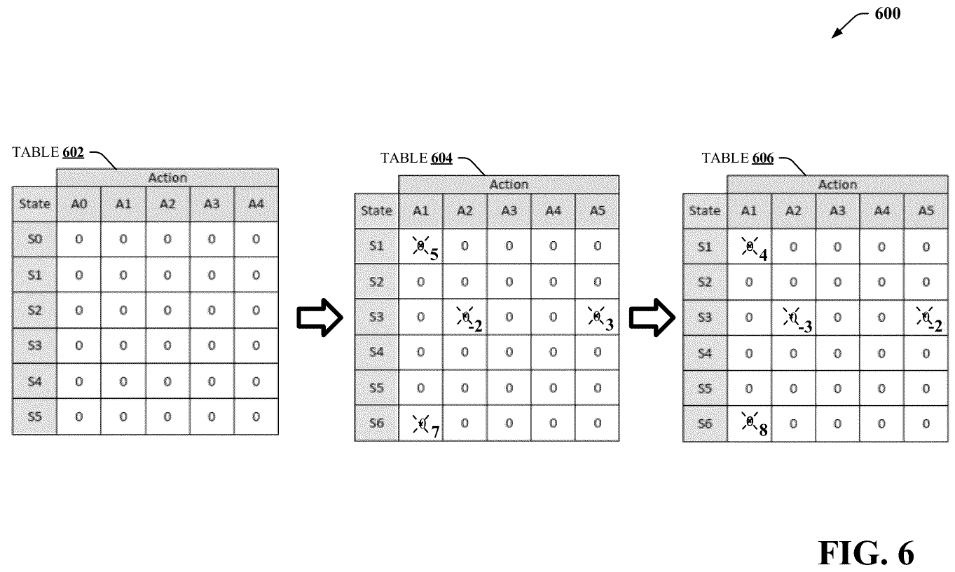

FIG. 6 illustrates an example, non-limiting Q-table construction process 600 that can be employed for training a reinforcement learning agent to identify a decoupling location for a space vehicle in an in-space manufacturing ecosystem in accordance with one or more embodiments described herein. One or more embodiments described with respect to FIG. 6 can be implemented by one or more components of system 100 illustrated in FIG. 1. Repetitive description of like elements and/or processes employed in respective embodiments is omitted for sake of brevity.

With continued reference to FIG. 5, a reinforcement learning model (e.g., model 118) can use Q-learning to learn a trajectory, wherein the reinforcement learning model can consider the decoupling point of the space vehicle (e.g., space vehicle 502) and one or more locations on Earth as respective independent states on a Q-table to learn the trajectory. The main objective of Q-learning can be to learn a policy which can inform an RL agent (e.g., the space vehicle, ship, aircraft, etc.) about actions that the RL agent can take for maximizing a reward under various circumstances. An input dataset for training the model can consist of known optimal paths from one location to another location, and the losses can be calculated if an agent (e.g., an RL agent) deviates from an expected path. A Q-table can be updated for each iteration till the agent can learn to reach a desired state following an optimal path. FIG. 6 illustrates Q-tables associated with training the reinforcement learning model described in one or more embodiments herein. FIG. 6 illustrates a Q-table construction process that can be employed during a training phase for an RL agent to identify the decoupling point for the space vehicle.

A Q-table (e.g., Q(s,a)) can be constructed for all actions that can be taken by an RL agent. The Q-table can comprise n columns and m rows wherein n can be the number of actions (e.g., A0 to A5), and m can be the number of states (e.g., S0 to S5). An existing state “s” of an RL agent can be observed by the RL agent, such that the RL agent can select a preferred action at the existing state to reach a desired next state. From the existing state, using an Epsilon-Greedy search algorithm, the RL agent can choose an action with a highest Q-value by balancing between exploration and exploitation. A most relevant action can be selected by the RL agent to traverse from the existing state to a next stable state, and the RL agent can perform the selected action to transit from the existing state “s” to the next stable state. The RL agent can observe and measure a reward for an action taken in a previous step. For example, a reward can be given to the RL agent for moving from the existing state “s” to the next stable state.

In the Epsilon-Greedy search algorithm, by adjusting an epsilon value, a trade-off between exploration and exploitation can be controlled. Smaller values of epsilon can encourage more exploitation, while larger values can promote more exploration. The primary operation can involve random selection of actions during exploration (epsilon probability) and selecting an action with a highest Q-value during exploitation. A sample epsilon value can be epsilon=0.2, wherein the epsilon value can be adjusted based on the needs. Exemplary Q-values for each action in a current state can be q_values=[0.5, 0.8, 0.3, 0.2]. Code 1 can describe a sample code to choose an action.

```
Code 1: if random.random( ) < epsilon:
  # Explore: Choose a random action with probability epsilon
  action = random.randint(0, len(q_values) − 1)
  else:
  # Exploit: Choose the action with the high
  est Q-value with probability (1 − epsilon)
  action = q_values.index(max(q_values))
```

Table 602 can illustrate a Q-table initialized to zero (e.g., Q(s,a)=0), table 604 can illustrate an updated version of table 602 (Q(s,a)) at time t=1, and table 606 can illustrate an update version of table 604 (Q(s,a)) at future time stamps. It is to be appreciated that all values mentioned in table 604 and table 606 are in vector format. In table 602, state S0 can indicate an initial state of the space vehicle (e.g., at the decoupling location). In table 604, state S1 can indicate a location on Earth where the space vehicle can land and states S2-S6 can indicate other states that can be reached by an RL agent by taking multiple actions. Based on an action taken by the RL agent, if the RL agent can reach an intended destination, the RL agent can be awarded positive reward points, otherwise the RL agent can be awarded a penalty (e.g., negative points). Further, the positive and negative rewards points can differ in values based on whether the RL agent can reach an intended destination directly or indirectly.

For example, action A1 can be an action taken by the space vehicle to travel from the decoupling point in space to a location on Earth. The space vehicle can be awarded positive 7 (+7) points if the space vehicle can traverse from S0 to S6, whereas the space vehicle can be awarded positive 5 (+5) points for traversing from S0 to S1. Thereafter, the space vehicle can perform action A2 to reach a point in S3, wherein the action can comprise transporting goods through cargo, and an RL agent can be awarded negative 2 (−2) points (i.e., get penalized), for example, if there is no way of reaching an intended destination from the point in S3. Contrarily, if the space vehicle performs action A5 to reach some other point in S3 (e.g., when a location where the space vehicle lands is different from a location from where cargo can begin), the RL agent can be awarded positive 3 (+3) points. Based on points awarded to the RL agent, as indicated in table 604 by the cross marked cells, the Q-table represented by table 604 can be updated to table 606 to reflect updated reward values. For example, the RL agent can observe and measure a reward for a transition and a temporal difference between the current state and the subsequent state, and the RL agent can update a Q-table. Table 604 can be generated from table 602 using equation 1 (Bellman Optimality equation) and table 604 can be updated to table 606 using equation 2 (Q-learning iteration). Equations 1 and 2 can be standard formulae used for reinforcement learning.

$${q}_{*} ( s , a ) = E [ {R}_{t + 1} + γ {max}_{{a}^{′}} {q}_{*} ( {s}^{′} , {a}^{′} ) ] , \qquad Equation 1$$

wherein q represents an action-value function or Q-value function.

$${q}^{new} ( s , a ) = ( 1 - α ) {\underbrace{q ( s , a )}}_{old value} + {\overbrace{α ( {R}_{t + 1} + γ max q ( {s}^{′} , {a}^{′} ) )} ,}^{learned value} \qquad Equation 2$$

wherein a represents a learning rate, a hyperparameter that needs to be tuned since a can control convergence.

In equations 1 and 2, R can represent a reward comprising a cumulative value for a state transition. Further, y (gamma) represents a discount factor that is a real number between 0 and 1, and y can determine how much weight is given to future rewards compared to immediate rewards. A higher discount factor (yy) can place more emphasis on long-term rewards and encourage an agent (e.g., an RL agent) to prioritize actions that can lead to higher cumulative rewards over time. Conversely, a lower discount factor can make an agent focus more on immediate rewards. E represents an estimate function to determine how good it is for the agent to take a given action from a given state when following a certain policy.

Thus, based on whether an RL agent can satisfy all conditions (e.g., whether the RL agent can deliver the manufactured products within a stipulated time, availability of transportation from one location on Earth to another, etc.) when traversing to an intended location, the RL agent can be awarded a maximum reward, otherwise the RL agent can be awarded a penalty. For example, the RL agent can be awarded a penalty for landing at an incorrect location. A typical RL agent can attempt to gain the maximum reward by traversing an optimal path to an intended destination. However, the path can be different in different scenarios. For example, a path to deliver the manufactured products to a location in the USA can be different if computed a month apart due to changing parameters, and the reinforcement learning model can learn the trajectory based on Q-learning. As stated elsewhere herein, an RL agent can be a space vehicle, ship, truck, train, aircraft, etc., based on a location.

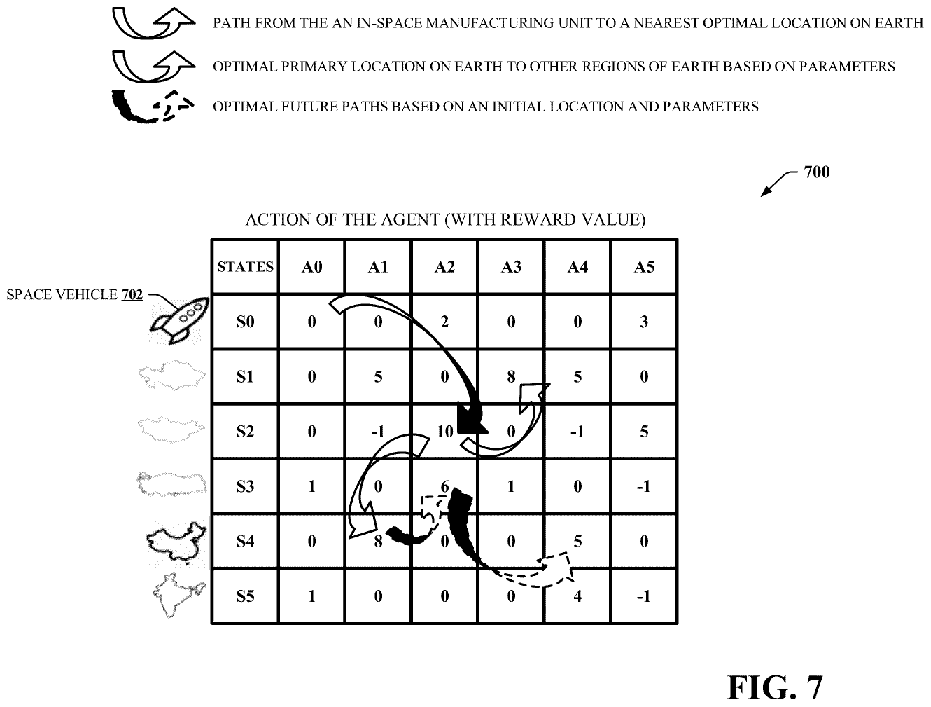

FIG. 7 illustrates an example, non-limiting Q-table 700 based on a state transition process that can be implemented by a reinforcement learning model for identifying a decoupling location for a space vehicle in an in-space manufacturing ecosystem in accordance with one or more embodiments described herein. One or more embodiments described with respect to FIG. 7 can be implemented by one or more components of system 100 illustrated in FIG. 1. Repetitive description of like elements and/or processes employed in respective embodiments is omitted for sake of brevity.

With continued reference to FIG. 5, Q-table 700 can illustrate rewards gained by an RL agent for actions taken by the RL agent to traverse from S0 to S5. As illustrated by the outlined maps in the left column of Q-table 700, S0 can represent a starting point of space vehicle 702 (i.e., at the decoupling point in space), S1 can represent a geographical location in Kazakhstan, S2 can represent a geographical location in Mongolia, S3 can represent a geographical location in Turkey, S4 can represent a geographical location in a first country in Asia and S5 can represent a geographical location in a second country in Asia. As further illustrated by the legend in FIG. 7, the arrow from S0 to S2 can indicate a path from an in-space manufacturing unit to a location on Earth that can be nearest to a delivery location for the manufactured products. The arrows from S2 to S1 and S2 to S4 can indicate paths from an optimal primary location on Earth (e.g., S2) to other respective regions on Earth (e.g., S1, S4) based on various parameters such as time duration, weather conditions, need of products, etc. The arrows from S4 to S3 and from S3 to S4 can indicate respective optimal future paths based on the initial location and the various parameters.

To identify a nearest optimal location on Earth to a delivery location based on parameters of time, need of products manufactured by the in-space manufacturing unit, environmental conditions, etc., an RL agent (e.g., space vehicle 702) can learn, based on input from a reinforcement learning model, an optimal trajectory to traverse from S0 to the delivery location. For example, even though S1 can be closer to S0, the reinforcement learning model can be trained to identify state S2 as a subsequent state to S0 where the RL agent can land, based on favorable weather conditions at S2, need of the manufactured products at S2, etc., such that the RL agent can traverse from S0 to S2. As stated elsewhere herein, an objective of Q-learning can be to learn a policy which can inform the RL agent (e.g., a space vehicle) about actions that the RL agent can take for maximizing a reward under various circumstances. As such, if the RL agent performs an action to traverse from S0 to S2, the RL agent can be awarded positive 10 (+10) points. From S2, if the RL agent (e.g., a ship, airplane, truck, etc.) performs an action to traverse to S1 or S4, the RL agent can be awarded positive 8 (+8) points. From S4, if the RL agent performs an action to traverse to S3, the RL agent can be awarded positive 6 (+6) points. Thereafter, if the RL agent performs an action to traverse from S3 to S4, the RL agent can be awarded positive (+5) points. Thus, an RL agent can learn a trajectory based on a Q-table that the RL agent can traverse for delivering products manufactured in space to a delivery location on Earth. In an embodiment, a system (e.g., system 100, delivery component 114) can deliver a space vehicle (e.g., space vehicle 702) from one in-space manufacturing unit to another in-space manufacturing unit based on the process of Q-learning, as described above.

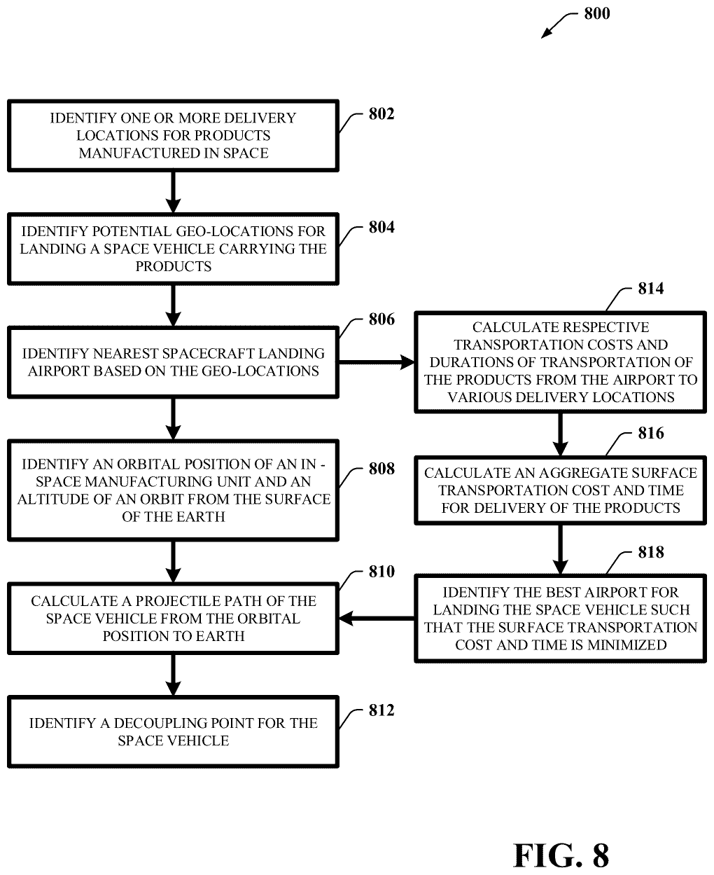

FIG. 8 illustrates a flow diagram of an example, non-limiting method 800 that can identify a decoupling location for a space vehicle in an in-space manufacturing ecosystem in accordance with one or more embodiments described herein. Repetitive description of like elements and/or processes employed in respective embodiments is omitted for sake of brevity.

At 802, the non-limiting method 800 can comprise identifying (e.g., by decoupling component 108), one or more delivery locations for products manufactured in space.

At 804, the non-limiting method 800 can comprise identifying (e.g., by decoupling component 108), potential geo-locations for landing a space vehicle carrying the products.

At 806, the non-limiting method 800 can comprise identifying (e.g., by decoupling component 108), a nearest spacecraft landing airport based on the geo-locations.

At 808, the non-limiting method 800 can comprise identifying (e.g., by decoupling component 108), an orbital position of an in-space manufacturing unit and an altitude of an orbit from the surface of the Earth.

At 810, the non-limiting method 800 can comprise calculating (e.g., by decoupling component 108), a projectile path of the space vehicle from the orbital position to the Earth.

At 814, the non-limiting method 800 can comprise calculating (e.g., by analysis component 112), respective transportation costs and durations of transportation of the products from the airport to the various delivery locations.

At 816, the non-limiting method 800 can comprise calculating (e.g., by analysis component 112), an aggregate surface transportation cost and time for delivery of the products.

At 818, the non-limiting method 800 can comprise identifying (e.g., by decoupling component 108), the best airport for landing the space vehicle such that the surface transportation cost and time can be minimized.

At 812, the non-limiting method 800 can comprise identifying (e.g., by decoupling component 108), a decoupling point for the space vehicle, based on steps 810 and 818.

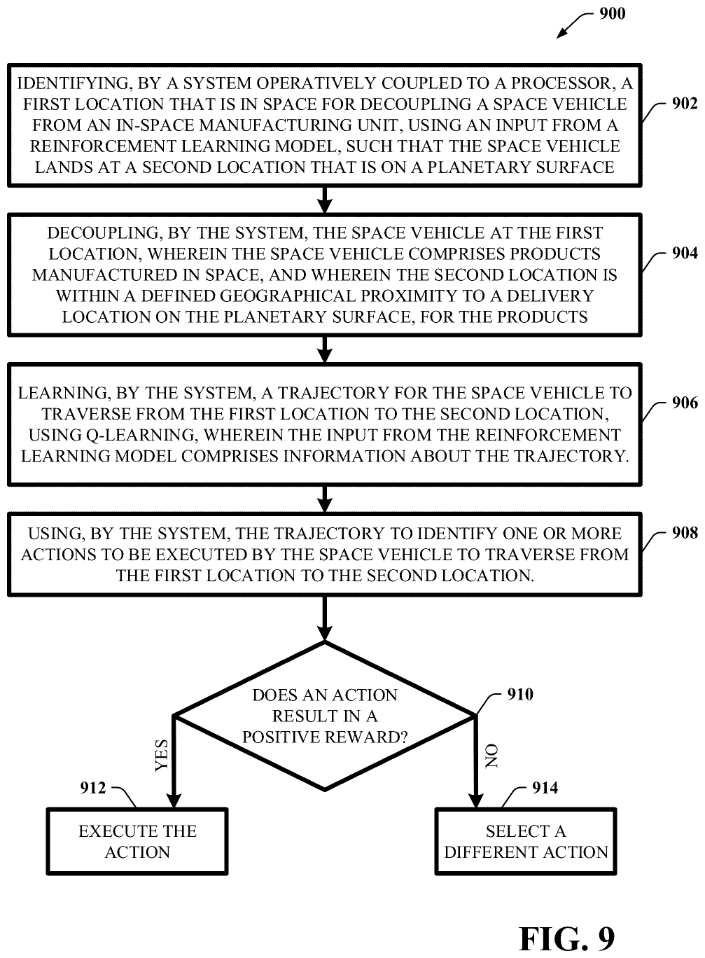

FIG. 9 illustrates another flow diagram of an example, non-limiting method 900 that can identify a decoupling location for a space vehicle in an in-space manufacturing ecosystem in accordance with one or more embodiments described herein. Repetitive description of like elements and/or processes employed in respective embodiments is omitted for sake of brevity.

At 902, the non-limiting method 900 can comprise identifying (e.g., by decoupling component 108), by a system operatively coupled to a processor, a first location that can be in space for decoupling a space vehicle from an in-space manufacturing unit, using an input from a reinforcement learning model, such that the space vehicle can land at a second location that can be on a planetary surface.

At 904, the non-limiting method 900 can comprise decoupling (e.g., by decoupling component 108), by the system, the space vehicle at the first location, wherein the space vehicle can comprise products manufactured in space, and wherein the second location can be within a defined geographical proximity to a delivery location on the planetary surface, for the products.

At 906, the non-limiting method 900 can comprise learning (e.g., by model 118), by the system, a trajectory for the space vehicle to traverse from the first location to the second location, using Q-learning, wherein the input from the reinforcement learning model can comprise information about the trajectory.

At 908, the non-limiting method 900 can comprise using (e.g., by action component 110), by the system, the trajectory to identify one or more actions to be executed by the space vehicle to traverse from the first location to the second location.

At 910, the non-limiting method 900 can comprise determining (e.g., by action component 110), by the system, whether an action can result in a positive reward.

If yes, at 912, the non-limiting method 900 can comprise executing (e.g., by action component 110), by the system, the action.

If no, at 914, the non-limiting method 900 can comprise selecting (e.g., by action component 110), by the system, a different action.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively identify a decoupling location in space for decoupling and releasing a space vehicle carrying products manufactured in space as the one or more embodiments described herein can enable this process. And, neither can the human mind nor a human with pen and paper compute an optimal trajectory for the space vehicle such that the space vehicle can land near a delivery location for the products, on a planetary surface, as conducted by one or more embodiments described herein.

FIG. 10 illustrates a block diagram of an example, non-limiting operating environment 1000 in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as space vehicle decoupling location computation code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed:

1. A system, comprising:
a memory that stores computer-executable components; and
a processor that executes the computer-executable components stored in the memory, wherein the computer-executable components comprise:
a decoupling component that uses an input from a reinforcement learning model to identify a first location that is in space for decoupling a space vehicle from an in-space manufacturing unit, such that the space vehicle lands at a second location that is on a planetary surface.

2. The system of claim 1, wherein the decoupling component decouples the space vehicle at the first location, wherein the space vehicle comprises products manufactured in space, and wherein the second location is within a defined geographical proximity to a delivery location on the planetary surface, for the products.

3. The system of claim 2, further comprising:
an analysis component that analyzes a warehouse area and an inventory on the planetary surface, to identify the first location for decoupling the space vehicle, such that a surface transportation cost and a transportation time associated with the products are maintained below respective defined thresholds.

4. The system of claim 2, further comprising:
a delivery component that delivers the space vehicle to a different in-space manufacturing unit, for landing the space vehicle at the second location, such that a surface transportation cost and a transportation time associated with the products are maintained below respective defined thresholds.

5. The system of claim 1, wherein the input comprises information about a trajectory for the space vehicle to traverse from the first location to the second location, and wherein the reinforcement learning model uses Q-learning to learn the trajectory.

6. The system of claim 5, wherein the reinforcement learning model considers the first location and the second location as respective independent states on a Q-table to learn the trajectory.

7. The system of claim 5, wherein the reinforcement learning model further considers environmental parameters, ground weather conditions, time needed to traverse a path from the first location to the second location and need of products comprised in the space vehicle to learn the trajectory.

8. The system of claim 5, further comprising:
an action component that uses the trajectory to identify one or more actions to be executed by the space vehicle to traverse from the first location to the second location.

9. The system of claim 1, wherein one or more ground manufacturing units collaborate with the in-space manufacturing unit and one or more ground supply chain units to identify the first location for decoupling the space vehicle while minimizing supply chain operations.

10. The system of claim 1, further comprising:
an engagement component that engages at least a second in-space manufacturing unit to deliver products comprised in the space vehicle to a third location on the planetary surface, in addition to the second location.

11. A computer-implemented method, comprising:
identifying, by a system operatively coupled to a processor, a first location that is in space for decoupling a space vehicle from an in-space manufacturing unit, using an input from a reinforcement learning model, such that the space vehicle lands at a second location that is on a planetary surface.

12. The computer-implemented method of claim 11, further comprising:
decoupling, by the system, the space vehicle at the first location, wherein the space vehicle comprises products manufactured in space, and wherein the second location is within a defined geographical proximity to a delivery location on the planetary surface, for the products.

13. The computer-implemented method of claim 12, further comprising:
analyzing, by the system, a warehouse area and an inventory on the planetary surface, to identify the first location for decoupling the space vehicle, such that a surface transportation cost and a transportation time associated with the products are maintained below respective defined thresholds.

14. The computer-implemented method of claim 12, further comprising:
delivering, by the system, the space vehicle to a different in-space manufacturing unit, for landing the space vehicle at the second location, such that a surface transportation cost and a transportation time associated with the products are maintained below respective defined thresholds.

15. The computer-implemented method of claim 11, further comprising:
learning, by the system, a trajectory for the space vehicle to traverse from the first location to the second location, using Q-learning, wherein the input from the reinforcement learning model comprises information about the trajectory.

16. The computer-implemented method of claim 15, wherein the reinforcement learning model considers the first location and the second location as respective independent states on a Q-table to learn the trajectory.

17. The computer-implemented method of claim 15, wherein the reinforcement learning model further considers environmental parameters, ground weather conditions, time needed to traverse a path from the first location to the second location and need of products comprised in the space vehicle to learn the trajectory.

18. The computer-implemented method of claim 15, further comprising:
using, by the system, the trajectory to identify one or more actions to be executed by the space vehicle to traverse from the first location to the second location.

19. A computer program product for identifying an appropriate decoupling point for a space vehicle in an in-space manufacturing ecosystem, the computer program product comprising a computer readable storage medium having program instructions embodied therewith, the program instructions executable by a processor to cause the processor to:
identify, by the processor, a first location that is in space for decoupling the space vehicle from an in-space manufacturing unit, using an input from a reinforcement learning model, such that the space vehicle lands at a second location that is on a planetary surface.

20. The computer program product of claim 19, wherein the program instructions are further executable by the processor to cause the processor to:
decouple, by the processor, the space vehicle at the first location, wherein the space vehicle comprises products manufactured in space, and wherein the second location is within a defined geographical proximity to a delivery location on the planetary surface, for the products.
